(19) United States
(12) Patent Application Publication
(10) Pub. No.: US 2024/0395124 A1
(43) Pub. Date: Nov. 28, 2024

(54) SYSTEM AND METHOD FOR EVALUATING LIFE SAFETY DETECTION DEVICES

(71) Applicant: Carrier Corporation, Palm Beach Gardens, FL (US)

(72) Inventors: Callum Bailey, Lakewood, FL (US); Slade Culp, Bradenton, FL (US)

(21) Appl. No.: 18/666,058

(22) Filed: May 16, 2024

Related U.S. Application Data
(60) Provisional application No. 63/504,551, filed on May 26, 2023.

(51) Int. Cl. G01N 15/075; G08B 17/107

(52) U.S. Cl. CPC G08B 17/107

(57) ABSTRACT

Embodiments of the disclosure describe systems and methods for evaluating an operational aspect of a life safety detection device. The method comprises transmitting light from at least one light source into a detection chamber positioned within an interior of a housing of the device. Further, the method comprises receiving, over a predefined time period, scattered light within the detection chamber, wherein the scattered light is indicative of a presence of airborne particulate matter. Furthermore, the method comprises determining, by a processor coupled to the device, a variation pattern of the airborne particulate matter during the predefined time period to analyze, by the processor, the variation pattern of the airborne particulate matter over the predefined time period with respect to another variation pattern during the predefined time duration to evaluate operational aspects of the device.

### CROSS REFERENCE TO RELATED APPLICATION

This application claims the benefit of U.S. Provisional Patent Application No. 63/504,551 filed on May 26, 2023, which is incorporated by reference herein in its entirety.

### FIELD OF THE INVENTION

The disclosure generally relates to life safety detection devices, and more particularly relates to evaluating one or more operational aspects of life safety detection devices (e.g., a smoke detector).

### BACKGROUND

Residential and commercial facilities may have life safety detection devices (e.g., photoelectric smoke detectors) that are used to warn occupants during an emergency situation (e.g., a fire). Conventional photoelectric smoke detectors include a light source and a photoelectric receiver to detect whether or not smoke is present in an optic/smoke chamber of the smoke detector. When there is no smoke in the optic/smoke chamber, and the optic chamber is empty or mostly empty, the photoelectric receiver typically receives a small amount of light reflected from the chamber surfaces. On the other hand, when smoke is present in the optic chamber, the photoelectric receiver receives more light due to the light being reflected from the smoke particles. When an amount of the light received by the receiver exceeds a certain threshold, an alarm is triggered. Such smoke detectors need to be periodically tested to check their smooth functioning to ensure safety of the occupants.

Currently, such smoke detectors have to be tested manually by at least two technicians, one at a fire panel and another one walking around with a “smoke-in-a-can” product, to verify the life-safety performance (i.e., smoke detection) of the smoke detector. For verifying smoke detection functionality, the manual testers have to verify whether the photo-sensor of the smoke detector is functioning correctly, and whether smoke can enter the smoke chamber, i.e., there are no obstructions in the surrounding area of the detector. This maintenance service is expensive to the customer and also consumes a lot of time.

Additionally, some current solutions use an active stimulus, such as heating of wax to generate particles to test optic/smoke chambers of such life safety detection devices. However, such testing processes are also costly and have high power-consumption, which can be problematic for low-power detection networks.

Therefore, in view of the above-mentioned problems, there is a need to provide a method and a system for efficient testing of aforementioned life safety detection devices, which may also reduce cost, eliminate the need for manual service, and/or save time.

### SUMMARY

This summary is provided to introduce a selection of concepts, in a simplified format, that are further described in the detailed description of the disclosure. This summary is neither intended to identify key or essential inventive concepts of the disclosure and nor is it intended for determining the scope of the disclosure.

Disclosed herein is a method of evaluating an operational aspect of a life safety detection device. The method comprises transmitting light from at least one light source into a detection chamber positioned within an interior of a housing of the life safety detection device. Further, the method comprises receiving, over a predefined time period, scattered light within the detection chamber, wherein the scattered light is indicative of a presence of airborne particulate matter. Furthermore, the method comprises determining, by at least one processor communicably coupled to the life safety detection device, a variation pattern of the airborne particulate matter during the predefined time period based on the received scattered light during the predefined time period. Still further, the method comprises analyzing, by the at least one processor, the variation pattern of the airborne particulate matter over the predefined time period with respect to another variation pattern during the predefined time duration. Additionally, the method comprises evaluating, by the at least one processor, the operational aspect associated with the life safety detection device based on the analyzing step.

In one or more embodiments, the determining comprises determining a variation pattern of the airborne particulate matter indicative of perturbation in the airborne particulate matter during an active stimulus associated with an event within a predefined threshold distance from the life safety detection device, and wherein the event perturbs air quality within the predefined threshold distance.

In one or more embodiments, the event comprises one of: activating or deactivating of a device within the predefined threshold distance, activating or deactivating of a sub-alarm threshold aerosol within the predefined threshold distance, change in state of one of a door, a window, or an object within the predefined threshold distance, and activating or deactivating of a ventilation system within the predefined threshold distance.

In one or more embodiments, the another variation pattern is associated with another life safety detection device within a predefined threshold distance from the life safety detection device.

In one or more embodiments, the another variation pattern is a predefined pattern associated with a ground truth airborne particulate matter detection device.

In one or more embodiments, the analyzing comprises determining whether a deviation between the variation pattern of the airborne particulate matter and the another variation pattern is within a predefined threshold, and the evaluating comprises evaluating that the life safety detection device is malfunctioning in response to a determining that the deviation is above the predefined threshold.

In one or more embodiments, the method further comprises transmitting, by the at least one processor, an alert indicating malfunctioning of the life safety detection device based on the evaluating step.

Also disclosed herein is a system for evaluating an operational aspect of a life safety detection device. The system comprises a life safety detection device comprising: a housing defining a detection chamber for receiving ambient materials; at least one light source configured to emit light into the detection chamber; and at least one light sensing device configured to receive, over a predefined time period, scattered light reflected from the ambient materials in the detection chamber, wherein the scattered light is indicative of a presence of airborne particulate matter. Further, the system comprises a processor communicably coupled to the life safety detection device. The processor is configured to: determine a variation pattern of the airborne particulate matter during the predefined time period based on the received scattered light at the life safety detection device during the predefined time period. Further, the processor is configured to analyze the variation pattern of the airborne particulate matter over the predefined time period with respect to another variation pattern during the predefined time duration. Furthermore, the processor is configured to evaluate the operational aspect associated with the life safety detection device based on the analysis.

In one or more embodiments, to determine the variation pattern, the processor is configured to determine a variation pattern of the airborne particulate matter indicative of perturbation in the airborne particulate matter during an active stimulus associated with an event within a predefined threshold distance from the life safety detection device, and wherein the event perturbs air quality within the predefined threshold distance.

In one or more embodiments, the event comprises one of: activating or deactivating of a device within the predefined threshold distance, activating or deactivating of a sub-alarm threshold aerosol within the predefined threshold distance, change in state of one of a door, a window, or an object within the predefined threshold distance, and activating or deactivating of a ventilation system within the predefined threshold distance.

In one or more embodiments, the another variation pattern is associated with another life safety detection device within a predefined threshold distance from the life safety detection device.

In one or more embodiments, the another variation pattern is a predefined pattern associated with a ground truth airborne particulate matter detection device.

In one or more embodiments, wherein: to analyze the variation pattern, the processor is configured to determine whether a deviation between the variation pattern of the airborne particulate matter and the another variation pattern is within a predefined threshold, and to evaluate the operational aspect, the processor is configured to evaluate that the life safety detection device is malfunctioning in response to a determining that the deviation is above a predefined threshold.

In one or more embodiments, the processor is further configured to transmit an alert indicating malfunctioning of the life safety detection device based on the evaluating step.

Also disclosed herein is a life safety detection device, comprising a housing defining a detection chamber for receiving ambient materials. Further, the life safety detection device comprises at least one light source configured to emit light into the detection chamber. Furthermore, the life safety detection device comprises at least one light sensing device configured to receive, over a predefined time period, scattered light reflected from the ambient materials in the detection chamber, wherein the scattered light is indicative of a presence of airborne particulate matter. Furthermore, the life safety detection device comprises a communication interface configured to transmit to a processor, communicably coupled to the life safety detection device, measurements associated with the received scattered light indicating presence of the airborne particulate matter for evaluation of an operational aspect of the life safety detection device.

Also disclosed herein is a method of evaluating an operational aspect of a life safety detection device. The method comprises transmitting light from at least one light source into a detection chamber positioned within an interior of a housing of the life safety detection device. Further, the method comprises receiving, over a predefined time period, scattered light within the detection chamber, wherein the scattered light is indicative of a presence of airborne particulate matter. Furthermore, the method comprises transmitting, to at least one processor communicably coupled to the life safety detection device, measurements associated with the received scattered light indicating presence of airborne particulate matter for evaluation of the operational aspect of the life safety detection device.

Also disclosed here is a system of evaluating an operational aspect of a life safety detection device. The system comprises at least one processor communicably coupled to the life safety detection device. The at least one processor is configured to receive, from the life safety detection device, measurements associated with received scattered light indicating presence of airborne particulate matter during a predefined time period. Further, the at least one processor is configured to determine a variation pattern of the airborne particulate matter during the predefined time period based on the received scattered light during the predefined time period. Furthermore, the at least one processor is configured to analyze the variation pattern of the airborne particulate matter over the predefined time period with respect to another variation pattern during the predefined time duration. Additionally, the at least one processor is configured to evaluate the operational aspect associated with the life safety detection device based on the analysis.

In one or more embodiments, to determine the variation pattern, the at least one processor is configured to determine a variation pattern of the airborne particulate matter indicative of perturbation in the airborne particulate matter during an active stimulus associated with an event within a predefined threshold distance from the life safety detection device, and wherein the event perturbs air quality within the predefined threshold distance.

In one or more embodiments, the event comprises one of: activating or deactivating of a device within the predefined threshold distance, activating or deactivating of a sub-alarm threshold aerosol within the predefined threshold distance, change in state of one of a door, a window, or an object within the predefined threshold distance, and activating or deactivating of a ventilation system within the predefined threshold distance.

In one or more embodiments, the another variation pattern is associated with another life safety detection device within a predefined threshold distance from the life safety detection device.

In one or more embodiments, the another variation pattern is a predefined pattern associated with a ground truth airborne particulate matter detection device.

In one or more embodiments, wherein: to analyze the variation pattern, the at least one processor is configured to determine whether a deviation between the variation pattern of the airborne particulate matter and the another variation pattern is within a predefined threshold, and to evaluate the operational aspect, the at least one processor is configured to evaluate that the life safety detection device is malfunctioning in response to a determining that the deviation is above a predefined threshold.

In one or more embodiments, the at least one processor is further configured to transmit an alert indicating malfunctioning of the life safety detection device based on the evaluating step.

Also disclosed herein is a method of evaluating an operational aspect of a life safety detection device. The method comprises receiving, by at least one processor communicably coupled to the life safety detection device, measurements associated with received scattered light at the life safety detection device indicating presence of airborne particulate matter during a predefined time period. Further, the method comprises determining, by the at least one processor, a variation pattern of the airborne particulate matter during the predefined time period based on the received scattered light during the predefined time period. Furthermore, the method comprises analyzing, by the at least one processor, the variation pattern of the airborne particulate matter over the predefined time period with respect to another variation pattern during the predefined time duration. Additionally, the method comprises evaluating, by the at least one processor, the operational aspect associated with the life safety detection device based on the analysis.

In one or more embodiments, the determining comprises determining a variation pattern of the airborne particulate matter indicative of perturbation in the airborne particulate matter during an active stimulus associated with an event within a predefined threshold distance from the life safety detection device, and wherein the event perturbs air quality within the predefined threshold distance.

In one or more embodiments, the event comprises one of: activating or deactivating of a device within the predefined threshold distance, activating or deactivating of a sub-alarm threshold aerosol within the predefined threshold distance, change in state of one of a door, a window, or an object within the predefined threshold distance, and activating or deactivating of a ventilation system within the predefined threshold distance.

In one or more embodiments, the another variation pattern is associated with another life safety detection device within a predefined threshold distance from the life safety detection device.

In one or more embodiments, the another variation pattern is a predefined pattern associated with a ground truth airborne particulate matter detection device.

In one or more embodiments, the analyzing comprises determining whether a deviation between the variation pattern of the airborne particulate matter and the another variation pattern is within a predefined threshold, and the evaluating comprises evaluating that the life safety detection device is malfunctioning in response to a determining that the deviation is above a predefined threshold.

In one or more embodiments, the method further comprises transmitting, by the at least one processor, an alert indicating malfunctioning of the life safety detection device based on the evaluating step.

To further clarify the advantages and features of the methods, systems, and apparatuses, a more particular description of the methods, systems, and apparatuses will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates an environment for evaluating an operational aspect of a life safety detection device, in accordance with one or more embodiments of the disclosure;

FIG. 2 illustrates a system for evaluating an operational aspect of the life safety detection device, in accordance with one or more embodiments of the disclosure;

FIG. 3a illustrates a perspective view of an exemplary life safety detection device, in accordance with one or more embodiments of the disclosure;

FIG. 3b illustrates a partially exploded view of the life safety detection device of FIG. 3a, in accordance with one or more embodiments of the disclosure;

FIG. 4 illustrates a planar view of a portion of the life safety detection device, in accordance with one or more embodiments of the disclosure;

FIG. 5 illustrates a perspective view of an exemplary optical chamber assembly of the life safety detection device, in accordance with one or more embodiments of the disclosure;

FIG. 6 illustrates a perspective view of a portion of the optical chamber assembly of FIG. 5, in accordance with one or more embodiments of the disclosure;

FIG. 7 illustrates a schematic diagram of an exemplary control system of the life safety detection device, in accordance with one or more embodiments of the disclosure;

FIG. 8 illustrates a flow diagram depicting an exemplary method at a system comprising a server and the life safety detection device for evaluating an operational aspect of the life safety detection device, in accordance with one or more embodiments of the disclosure;

FIG. 9 illustrates a flow diagram depicting an exemplary method at the life safety detection device for evaluating the operational aspect of the life safety detection device, in accordance with one or more embodiments of the disclosure;

FIG. 10 illustrates a flow diagram depicting an exemplary method at a server for evaluating the operational aspect of the life safety detection device, in accordance with one or more embodiments of the disclosure; and

FIG. 11 illustrates a graphical representation of measurements associated with particulate matter at the life safety detection device, in accordance with one or more embodiments of the disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment”, “some embodiments”, “one or more embodiments” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

In addition to overcoming the aforementioned challenges related to manual, time-consuming, and/or costly processes to test life safety detection devices, the disclosure provides for a dual-purpose life safety detection device, such as a smoke detector. Specifically, the indoor air quality is currently being monitored by separate indoor air quality sensors which detect presence of air pollutants, such as PM2.5 and PM10. Commercially available indoor air quality sensors typically use a laser and a fan to supply air to the interior of the sensor. Integration of such a sensor into an existing smoke detector is challenging because the laser consumes more power than is typically available within the smoke detector. Further, the size of existing smoke detector(s) and the space available inside such detector(s) imposes limitations for integration of such sensor(s). In addition, inclusion of the fan poses a risk of blowing smoke away from the smoke detector. A dual-purpose life safety detection device, such as a smoke detector, which detects pollutants is described in U.S. patent application Ser. No. 18/165,542 titled “COMBINATION SMOKE AND AIR QUALITY DETECTION” filed on Feb. 7, 2023, which claims the benefit of U.S. Provisional Patent Application Ser. No. 63/307,837, filed on Feb. 8, 2022, the contents of which are incorporated by reference herein in their entirety. US Provisional Patent application xx, assigned to Carrier Corporation is incorporated herein by reference in its entirety.

Embodiments of the disclosure are directed towards evaluating one or more operational aspects of a life safety detection device based on monitoring of particulate matter at the life safety detection device. The monitored particulate matter may be compared with pre-existing air-quality trend data to infer that the life safety detection device is functioning in a smooth manner. More specifically, the evaluation of the one or more operational aspects based on monitoring of particulate matter verifies functionality of smoke detection, photo-sensor, and whether smoke can enter the smoke chamber.

Embodiments of the disclosure will be described below in detail with reference to the accompanying drawings.

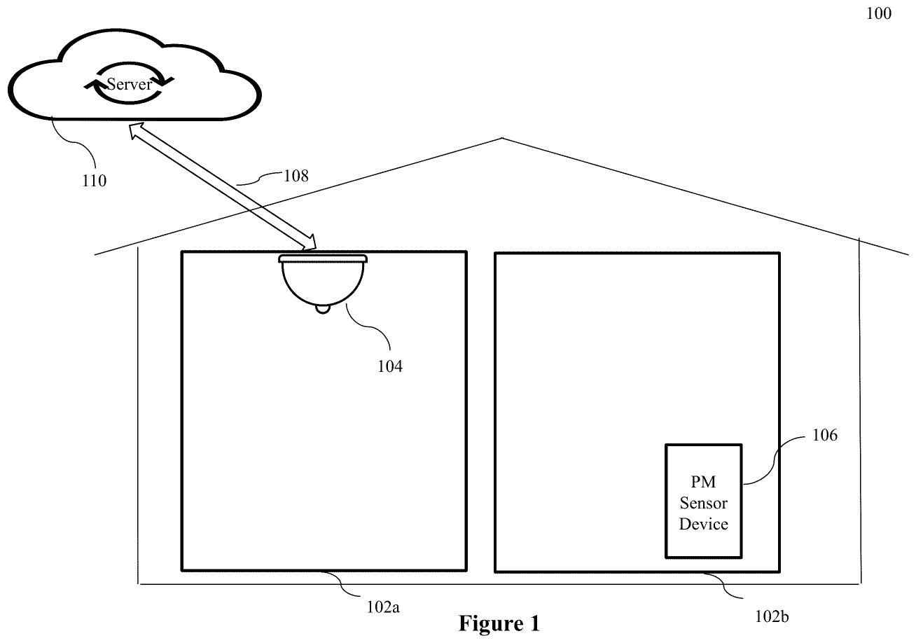

FIG. 1 illustrates an environment for evaluating an operational aspect of a life safety detection device.

In one exemplary embodiment, the environment 100 may include one or more areas 102a and 102b of a residential or commercial property. The areas 102a-102b may correspond to, but not limited to, a living room area, a bedroom, and a conference room. The environment 100 may include one or more devices, such as, but not limited to, a life safety detection device 104 and a particulate matter (PM) sensor device 106, as discussed throughout the disclosure. Such area is shown only for illustrative purposes, and a person skilled in the art would understand that the environment may include other areas as well comprising one or more aforementioned devices, without departing from the scope of the disclosure.

In an embodiment, the life safety detection device 104 may be a smoke detector, which may be configured to detect smoke and trigger an alarm to indicate a hazard (e.g., fire) as an indicator for occupants to evacuate the area 102a-102b. Further, the life safety detection device 104 may be configured to detect and measure airborne particulate matter, such as PM 2.5 and PM 10 within the area 102a-102b. For detecting/measuring the airborne particulate matter, the life safety detection device 104 may include at least one light source (e.g., a light emitting diode) and a detection chamber positioned within an interior of a housing of the life safety detection device 104, wherein the light source may be configured to transmit light into a detection chamber. The detection chamber may be configured to receive scattered light over a predefined time period, wherein the scattered light is indicative of a presence of the airborne particulate matter. The detailed components, such as the light source and the detection chamber, of the life safety detection device 104 are explained later throughout the disclosure.

Further, the life safety detection device 104 may be configured to transmit measurements associated with the airborne particulate matter, to the server 110, for evaluation of one or more operational aspects of the life safety detection device 104. The one or more operational aspects may include, but not limited to, functioning of at least one sensor inside the life safety detection device 104, whether smoke is able to enter a smoke chamber of the life safety detection device 104, and whether there are any obstructions in an area surrounding the life safety detection device 104.

In an embodiment, the environment 100 may include the server 110, which may be communicably coupled to the life safety detection device 104. In an embodiment, the server 110 may be a cloud-based server coupled to the life safety communication device 104 via a communication network 108. The server 110 may also include one or more machine learning models trained to determine a pattern based on the measurements, as received from the life safety detection device 104, and to analyze the pattern associated with the airborne particulate matter, as explained throughout the disclosure.

Specifically, the server 110 may be configured to receive measurements associated with the airborne particulate matter (or scattered light) from the life safety detection device 104 to evaluate the functioning of the life safety detection device 104. The measurements may be received corresponding to a predefined time period, such as, but not limited to, 30 mins to 1 hour. In an embodiment, the server 110 may be configured to determine a variation pattern of the airborne particulate matter during the predefined time period based on the received scattered light during the predefined time period.

In one embodiment, the server 110 may be configured to determine the variation pattern of the airborne particulate matter indicative of one or more perturbations in the airborne particulate matter within a predefined threshold distance from the life safety detection device 104. The variation pattern may subsequently be compared with another variation pattern during the predefined time duration. For instance, the another variation pattern may be associated with another life safety detection device located within the same area 102a-102b or the building observed during the same period. In such an embodiment, the server 110 may also be configured to receive particulate matter measurements associated with the other such device during the same period. In another exemplary embodiment, the another variation pattern may be a predefined pattern associated with a ground truth airborne particulate matter detection device 106. The detection device 106 may include, but not limited to, an air purifier, or any device comprising a particulate matter sensor. In yet another embodiment, the another variation pattern may be associated with a pre-defined pattern of the particulate matter available at the server that may correspond to an ideal pattern that should have been observed for the life safety detection device 104.

In another embodiment, the server 110 may be configured to determine the variation pattern of the airborne particulate matter indicative of one or more perturbations in the airborne particulate matter during an active stimulus associated with an event within a predefined threshold distance from the life safety detection device 104. The events may perturb the air quality within such predefined threshold distance from the life safety detection device 104, thereby modifying the detection/measurement of particulate matter by the life safety detection device 104 during the event. The event/perturbations may be determined by constantly determining some errors in the variation pattern, which account for variable/unforeseen events, such as door openings. The variation pattern may then be compared with another variation pattern during the predefined time duration to confirm such events and also estimate a confidence level in correct determination of such events. Additionally, in some embodiments, the variation pattern observed during the same time duration may be correlated with data from one or more access systems comprising one or more door sensors to determine a confidence level in detection of such events related to door openings. However, in one embodiment, if the estimated confidence, upon comparison of the variation pattern with another variation patterns or sensor data, drops below a predefined threshold level, a deviation state may be indicated, and if the deviation persists, then the server 110 may produce a maintenance fault after a predetermined period.

In one embodiment, the event may include activating or deactivating of a device and/or a ventilation system within the predefined threshold distance. For instance, activating an air purifier, a fan, or a ventilation system may perturb/modify air quality within vicinity of the life safety detection device 104. In another embodiment, the event may include activating or deactivating of a sub-alarm threshold aerosol within the predefined threshold distance. For instance, a diffuse salt spray through the ventilation system may perturb air quality around the life safety detection device 104 and observing reproducible propagation behavior to indicate normal function. In yet another embodiment, the event may include change in state of one of a door, a window, or an object within the predefined threshold distance. For instance, the opening or closing of a door window may modify air flow within the area 102a, thereby causing a perturbation in the particulate matter around the life safety detection device 104.

The server 110 may be configured to determine the pattern(s) based on the received measurements using a trained artificial intelligence model or a data science model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model (e.g., a neural network) may include a plurality of neural network layers. Each layer has a plurality of weight values and performs a neural network layer operation through calculation between a result of computation of a previous layer and an operation of a plurality of weights. In particular, the server 110 may include one or more ML based artificial intelligence models that are used for processing of the received measurements associated with the life safety detection device 104 and determine a pattern of variation for the measurements.

Further, the server 110 may be configured to analyze the variation pattern of the airborne particulate matter over the predefined time period with respect to another variation pattern during the predefined time duration. In an exemplary embodiment, the another variation pattern may be associated with a different life safety detection device within a predefined threshold distance from the life safety detection device 104. For instance, the another variation pattern may be associated with another life safety detection device located within the same area 102a-102b or the building. In another exemplary embodiment, the another variation pattern may be a predefined pattern associated with a ground truth airborne particulate matter sensor in the detection device 106. The detection device 106 may include, but not limited to, an air purifier, or any device comprising a particulate matter sensor. In yet another embodiment, the another variation pattern may be associated with a pre-defined pattern of the particulate matter available at the server 110 that may correspond to an ideal pattern to be observed during one or more pre-defined events observed around the life safety detection device 104. In an alternative embodiment, one or more functions performed by the server 110 may be locally performed by a processor and a memory included within the life safety detection device 104.

Furthermore, to perform the said analysis, the server 110 may perform a passive trend analysis which can be achieved by monitoring via life safety detection devices in geometric proximity to each other and performing a statistical analysis, to verify whether a systemic change in correlation has not occurred over time. For example, 7-day or 30-day average of a correlation coefficient may remain within a historically-observed range. Such metrics would be unique to a given deployment but would remain relatively constant over time unless an anomaly has occurred to an individual detector.

Furthermore, the server 110 may be configured to evaluate the operational aspect(s) associated with the life safety detection device 104 based on the aforementioned analysis of the pattern with respect to another pattern. Based on the analysis, the server 110 may be configured to conclude a consistent behavior or absence of any anomalies with respect to the another pattern. Such conclusion may indicate proper functioning of the particulate matter detection as well as normal functioning of smoke detection feature with respect to the ability of the particles to enter the smoke chamber in the life safety detection device 104. On the other hand, if the server detects a deviation from the normal with respect to the other particulate matter pattern, an alert may be transmitted to a third party (e.g., maintenance department for life safety detection device 104) for manual inspection of the life safety detection device 104. Thus, the evaluation of such operational aspects of the life safety detection device 104 in this manner provides an automated testing (no manual intervention) method for such devices.

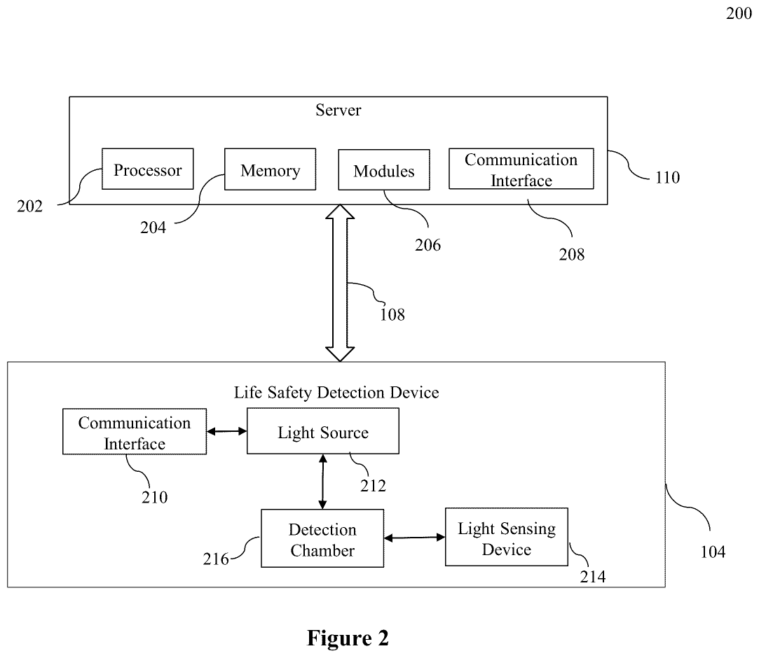

FIG. 2 illustrates a system 200 for evaluating the operational aspect of the life safety detection device 104.

As illustrated, the system 200 comprises the server 110 and the life safety detection device 104. In one embodiment, the server 110 may comprise a processor 202, a memory 204, one or more modules 206, and a communication interface 208. The life safety detection device 104 may comprise a communication interface 210, a light source 212, and a light sensing device 214.

In one embodiment, the life safety detection device 104 may include a housing (not shown in FIG. 2) defining a detection chamber 216 for receiving ambient materials, such as particulate matter of a predefined size in microns (e.g., PM 2.5 and PM 10). Further, the light source 212 may be configured to emit/transmit light into the detection chamber 216 positioned within an interior of the housing of the life safety detection device 104. Further, the light sensing device 214 may be configured to receive, over a predefined time period, scattered light within the detection chamber 216, wherein the scattered light is indicative of a presence of the airborne particulate matter in the life safety detection device 104.

In one embodiment, each of the communication interfaces 208 and 210 may include a transmitter and a receiver, and may be configured to communicate with each other via communication network 108, such as a wireless communication protocol. In one embodiment, the communication interface 210 of the life safety detection device 104 may be configured to indirectly communicate with the server 110. Specifically, the communication interface 210 may be configured to provide measurements associated with the particulate matter (i.e., the scattered light) to one or more devices (e.g., a router, a gateway, a fire panel, etc.) located within the area 102a-102b via wired or wireless communication. Subsequently, the one or more devices may be configured to transmit the measurements to the server 110 wirelessly. Additionally, the communication interface 208 coupled with the processor 202 may be configured to transmit an alert indicating malfunctioning of the life safety detection device 104 based on the evaluation of the operational aspects of the life safety detection device 104. The communication interfaces 208 and 210 may be configured for communicating internally between internal hardware components and with external devices, e.g., the life safety detection device 104 as well as the PM sensor device 106 (as shown in FIG. 1), via one or more networks (e.g., radio technology). The communication interfaces 208 and 210 may each include an electronic circuit specific to a standard that enables wired or wireless communication.

In one embodiment, the processor(s) 202 of the server 110 may be configured to receive the measurements associated with the particulate matter from the life safety detection device 104 and evaluate one or more operational aspects of the life safety detection device 104 based on an analysis of the measurements, as discussed throughout the disclosure.

Further, the processor(s) 202 may be configured to communicate with the memory 204 to store the received measurements for processing and evaluating the operational aspects of the life safety detection device 104. In an embodiment, the processor(s) 202 may be one or more microprocessor(s) or microcontroller(s). The processor 202 may include one or a plurality of processors, may be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

In some embodiments, the memory 204 may store data, instructions executable by the processor(s) 202 to perform the methods of evaluating the operational aspects of the life safety detection device 104, as discussed throughout the disclosure. The memory 204 may further include, but not limited to, a non-transitory computer-readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. Further, the non-transitory computer-readable storage media of the memory 204 may include executable instructions in a form of the modules 206 and a database to store data. The modules 206 may include a set of instructions that may be executed to cause the server 110 to perform any one or more of the methods for evaluating operational aspects of the life safety detection device 104 based on received measurements associated with the particulate matter, as disclosed herein throughout the disclosure. Specifically, the one or more modules 206 may be configured to perform the steps of the present disclosure using the data stored in the database of the memory 204 for evaluating operational aspects of the life safety detection device 104. In another embodiment, the modules 206 may be one or more hardware units which may be outside the memory 204. In one embodiment, the memory 204 may communicate via a bus within the processor(s) 202.

Further, in one embodiment, the server 110 may store one or more machine learning models in the memory 204 for evaluating the operational aspects of the life safety detection device 104, as discussed herein. In another embodiment, the server 110 may be coupled to a remote database via the communication interface 208, wherein the remote database may be configured to store machine learning models trained to perform one or more steps of the methods to evaluate the operational aspects of the life safety detection device 104.

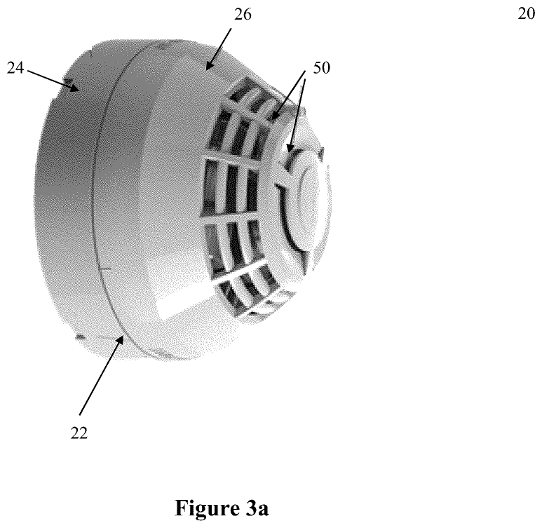

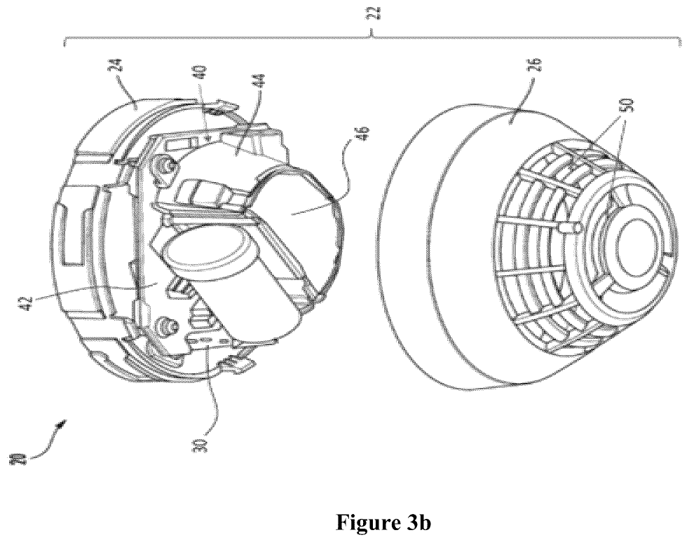

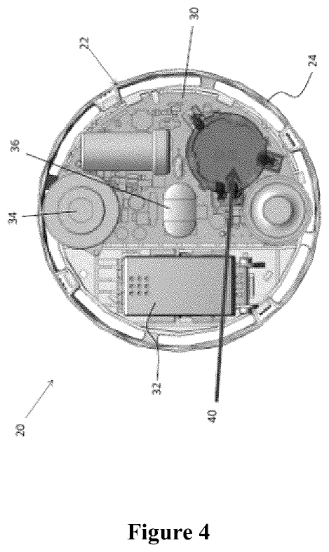

FIG. 3a illustrates a perspective view of the exemplary life safety detection device 104. FIG. 3b illustrates a partially exploded view of the life safety detection device 104 of FIG. 3a. FIG. 4 illustrates a planar view of a portion of the life safety detection device 104. FIGS. 3a, 3b, and 4 are described in conjunction with each other for the sake of ease of explanation.

With reference now to FIGS. 3a, 3b, and 4, an example of a life safety detection device 20, such as a photoelectric smoke detector or alarm for example, is illustrated. The life safety detection device 20 may correspond to the life safety detection device 104, as explained previously in conjunction with FIGS. 1 and 2. As shown, the life safety detection device 20 includes a housing 22 including a first upper housing portion 24 and a second lower housing portion 26 that is permanently or removably connected to the first housing portion 24. When the first and second housing portions 24, 26 are connected, the first and second housing portions 24, 26 enclose the controls and other components necessary for operation of the device 20. As used herein, the terms “upper”, “lower”, and the like are in reference to the device 20 in use as it is mounted on a surface, such as a ceiling in a building for example. Therefore, the upper housing portion 24 is typically closer to the ceiling than the lower housing portion 26, and the lower housing portion 26 is typically the portion of the device 20 that will face downward toward the floor of the building. In some embodiments, device 20 may be mounted on a wall such that upper housing portion 24 is closer to the wall than the lower housing portion 26, and the lower housing portion 26 is typically the portion of the device 20 that will face outward toward the interior space of the room or space to be monitored.

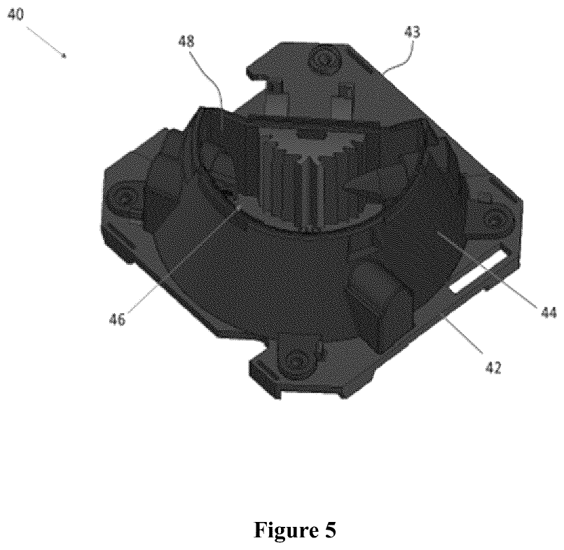

As shown in FIGS. 4 and 5, the life safety detection device 20 further includes controls including a printed circuit board 30 disposed within the first housing portion 24. The printed circuit board 30 includes the circuitry and/or components associated with at least one detection circuit (not shown) and at least one alarm circuit (not shown). In some embodiments, the device 20 may be hardwired to a power source (not shown) located within the building or area where the device 20 is mounted, remote from the device 20. In such embodiments, the printed circuit board 30 may be directly or indirectly connected to the power source. In an embodiment, the device 20 may include a compartment 32 for receiving one or more batteries sufficient to provide the power necessary to operate the device 20 for an extended period of time. In an embodiment, the power provided by the batteries may be the sole source of power used to operate the device 20. However, in other embodiments, the battery power may be supplemental to the remote power source, for example in the event of a failure or loss of power at the power source.

A sound generation mechanism 34 may be connected to the printed circuit board 30 within the housing 22. The sound generation mechanism 34 may be operable to receive power from the printed circuit board 30 to generate a noise in response to detection of a condition. In addition, one or more actuatable mechanisms 36, such as a button for example, may be connected to the printed circuit board 30 and is received within an opening formed in the second housing portion 26. The actuatable mechanism 36 may be configured to perform one or more functions of the life safety detection device 20 when actuated. Examples of operations performed via the actuatable mechanism 36 include, but are not limited to, a press to test function, a smoke alarm “hush”, a low battery “hush”, and end of life “hush”, radio frequency enrolment of additional life safety detection devices 20 such as in a detection system including a plurality of life safety detection devices configured to communicate with one another wirelessly, and to reset the unit once removed from its packaging. Although the actuatable mechanism 36 is shown positioned at the center of the second housing portion 26, embodiments where the actuatable mechanism 36 is located at another position are also within the scope of the disclosure.

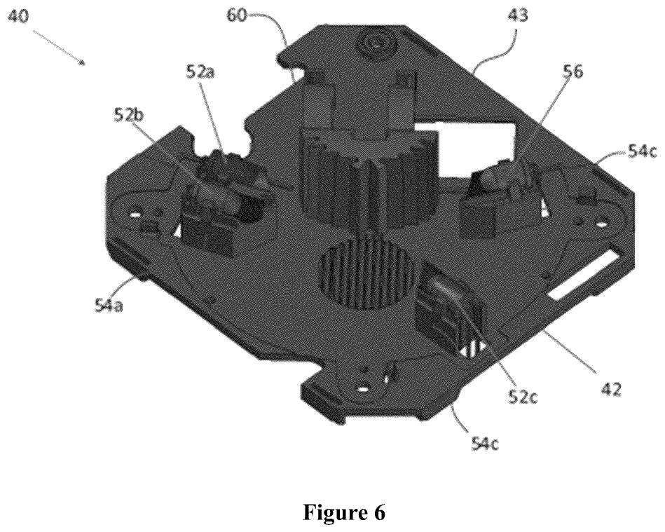

With continued reference to FIG. 4 and further reference to FIGS. 5 and 6, the life safety detection device 20 additionally includes one or more components that define an optical chamber assembly 40 within the interior of the housing 22. The optical chamber assembly 40 is generally open to or in fluid communication with the area surrounding the life safety detection device 20 and is thus receptive of ambient materials through a grating or another similar feature. The ambient materials may include air as well as smoke and non-smoke particles that are carried by the air.

The optical chamber assembly 40 includes a base 42. The circuit board 30 may be positioned between the base 42 and the first housing portion 24 to mechanically support and electrically connect electronic components of the device 20. An optical cover 44 is removably or permanently attached to the base 42 adjacent to a first surface 43 thereof. Accordingly, a detection chamber 46 is formed between the interior surface 48 of the optical cover 44 and the surface 43 of the base 42.

As shown in FIG. 3a, the second housing portion 26 includes at least one entry portion 50 through which air having particles entrained therein may enter into the life safety detection device 20. The second housing portion 26 may be connectable to the first housing portion 24 in overlapping arrangement with the optical cover 44. As a result, the one or more entry portions 50 are arranged in fluid communication with and form part of a fluid flow path for delivering air and any particles entrained therein from the atmosphere surrounding the device 20 into the detection chamber 46.

As shown in FIG. 6, the optical chamber assembly 40 additionally includes at least one light source, such as a light emitting diode for example. In the illustrated, non-limiting embodiment, the at least one light source includes a first light source 52a, a second light source 52b, and a third light source 52c. However, it should be understood that embodiments having a single light source, two light sources, or more than three light sources, are within the scope of the disclosure. The base 42 includes at least one mounting portion for supporting the at least one light source. As shown, the first light source 52a and the second light source 52b are arranged at a first mounting portion 54a relative to the base 42. Embodiments where the first light source 52a and the second light source 52b are mounted to distinct mounting portions at the same or different locations relative to the detection chamber 46 are contemplated herein.

The first light source 52a and the second light sources 52b may be selected to emit light having different wavelengths. For example, the first light source 52a may emit a first light having a first color and the second light source 52b may emit a second light having a second, distinct color. Alternatively, the first light source 52a may emit a first light within a visible spectrum and the second light source 52b may emit a second light outside of the visible spectrum, such as infrared light for example.

A second mounting portion 54b, located remotely from the first mounting portion 54a, may be configured to support the third light source 52c. Further, in an embodiment, the third light source 52c is arranged at an angle to the light emitted by the first and second light sources 52a, 52b and may emit light having the same wavelength and/or color or a different wavelength and/or color than the first and second light sources 52a, 52b. It should be understood that in an embodiment, a single light source, such as the first light source 52a for example, may be operable to emit light at two or more different wavelengths. Examples of such a light source include, but not limited to, a bi-color LED. In such embodiments, the optical chamber assembly 40 may have only the single light source, or alternatively, may include multiple light sources, at least one of which is configured to emit light at a plurality of different wavelengths.

The optical chamber assembly 40 additionally includes at least one light sensing device or light receiver 56. Examples of the light sensing device or the light receiver 56 include, but are not limited to a photodiode, an Avalanche PhotoDiode (APDs), a Multi-Pixel Photon Counters (MPPCs), or another suitable photodetector. Although a single light receiver 56 is illustrated in the figures, it should be understood that in other embodiments, the optical chamber assembly 40 may include two or more light receivers. In an embodiment, a third mounting portion 54c, separate from the first and second mounting portions 54a, 54b, is operable to support the light receiver 56.

As shown in FIG. 6, the light receiver 56 is disposed to receive light that is emitted by one of the light sources 52a, 52b, 52c and that is then reflected by the ambient materials within the detection chamber 46 toward the light receiver 56. Although not shown in the Figures, the light emitted from each of the light sources defines an emitter cone. Accordingly, in the illustrated, non-limiting embodiment, the light emitted from the first light source 52a defines a first emitter cone, the light emitted by the second light source 52b defines a second emitter cone, and the light emitted by the third light source 52c defines a third emitter cone. The at least one light receiver 56 similarly has a receiving cone associated therewith. The volume where each emitter cone overlaps with the receiving cone is defined as a sensing volume. Accordingly, in the illustrated, non-limiting embodiment, a first sensing volume is defined between the first emitter cone and the receiving cone, a second sensing volume is defined between the second emitter cone and the receiving cone and a third sensing volume is defined between the third emitter cone and the receiving cone.

The light receiver 56 may be configured to generate an electric output signal in accordance with light being received. That is, for light that is emitted by the first light source 52a, reflected by the ambient materials in the detection chamber 46 and then received by the light receiver 56, the light receiver 56 generates a first output signal. Similarly, for light that is emitted by the second and third light sources 52b, 52c, reflected by the ambient materials in the detection chamber 46 and then received by the light receiver 56, the light receiver 56 generates a second and third output signal, respectively. It should be understood that in addition to each of the light sources 52a, 52b, 52c being arranged at an angle relative to the light receiver 56, each of the mounting portions 54a, 54b, 54c may be oriented such that the corresponding light source 52a, 52b, 52c or light receiver 56 located thereat is arranged at a desired angle relative to a horizontal plane.

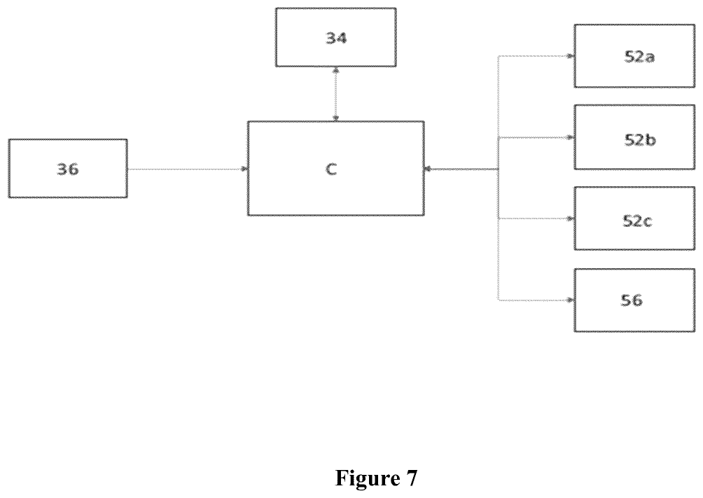

With reference now to FIG. 7, the life safety detection device 20 further includes a processing device C (e.g., a processor) in electrical communication with the plurality of light sources 52a, 52b, 52c, and the light receiver 56. The processing device C may be capable of accessing executable instructions or may include a memory (not shown) capable of storing executable instructions. The executable instructions may be stored or organized in any manner and at any level of abstraction, such as in connection with one or more applications, processes or routines to analyze the signals detected by the one or more light receivers to make alarm decisions after pre-set threshold levels are reached according to the method described herein.

The life safety detection device 20 may be operable in a plurality of modes. In an embodiment, the life safety detection device 20 is configured to detect the presence of smoke within the ambient atmosphere surrounding the life safety detection device 20 during operation in a first mode and is configured to monitor the indoor air quality of the ambient atmosphere surrounding the life safety detection device 20 during operation in a second mode. Monitoring of the indoor air quality as described herein relates to the detection of dust or other airborne particles referred to as PM2.5 particles (those particles having a diameter of 2.5 micrometers or less) and PM10 particles (those particles having a diameter of 10 micrometers or less).

In an embodiment, the life safety detection device 20 includes additional components or electronics associated with operation in the second or “indoor air quality” mode. Such components may be used to improve the detection sensitivity of the life safety detection device 20. In an embodiment, the additional components include an analog to digital converter and/or an optical filter. The optical filter may be configured to filter out undesired wavelengths, such as wavelengths outside of the wavelengths emitted by the light sources 52a, 52b, and 52c, or to preferentially detect with a specific polarization or scattered light from PM2.5 particles or smoke particles over light reflected from the side of the chamber.

One or more parameters associated with sampling of the atmosphere within the detection chamber 46 of the optical chamber assembly 40, may be the same, or alternatively, may vary based the mode of operation of the life safety detection device 20. For example, the sensing volumes and/or wavelengths may be different for the smoke detection mode and indoor air quality mode. Alternatively, or in addition, operation in the indoor air quality mode may include amplification of the detection circuit at the processor C, such as by using additional bits on the analog to digital converter to increase the resolution of the signal. Further, the indoor air quality mode may have an increased time during which at least one light source 52a-52c is energized compared to operation in the first “smoke detection” mode, and/or increased intensity or brightness of light emitted by a light source 52a-52c (due to an increased power input) relative to operation in the “smoke detection” mode. In an embodiment, the reference voltage of the analog to digital converter varies between the smoke detection mode and the indoor air quality mode.

The life safety detection device 20 may be configured to automatically transform between operation in the first smoke detection mode and operation in the second indoor air quality mode at predetermined intervals. In response to detection of an increased presence of smoke or the particulate matter, such as a level that is not elevated enough to trigger an alarm, the timing of the intervals may be delayed or paused. Further, the intervals at which measurements are taken during operation in the smoke detection mode may be the same, or alternatively, may be different than the intervals at which measurements are taken during operation in the indoor air quality mode. Further, it should be understood that embodiments where operation in either mode includes continuous monitoring rather than sampling at intervals is also within the scope of the disclosure.

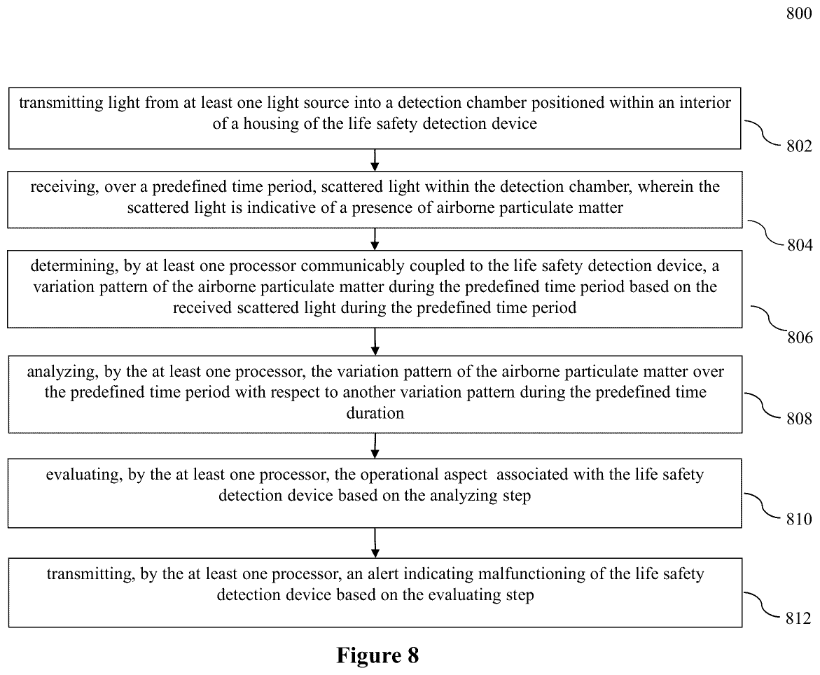

FIG. 8 illustrates a flow diagram depicting an exemplary method at a system (e.g., 200) comprising a server (e.g., 110) and a life safety detection device (e.g., 104) for evaluating an operational aspect of a life safety detection device.

At step 802, the method 800 comprises transmitting light from at least one light source into a detection chamber positioned within an interior of a housing of the life safety detection device.

At step 804, the method 800 comprises receiving, over a predefined time period, scattered light within the detection chamber, wherein the scattered light is indicative of a presence of airborne particulate matter.

At step 806, the method 800 comprises determining, by at least one processor communicably coupled to the life safety detection device, a variation pattern of the airborne particulate matter during the predefined time period based on the received scattered light during the predefined time period. In one embodiment, the determining comprises determining a variation pattern of the airborne particulate matter indicative of perturbation in the airborne particulate matter during an active stimulus associated with an event within a predefined threshold distance from the life safety detection device, and wherein the event perturbs air quality within the predefined threshold distance. The event may include one or more of activating or deactivating of a device within the predefined threshold distance, activating or deactivating of a sub-alarm threshold aerosol within the predefined threshold distance, change in state of one of a door, a window, or an object within the predefined threshold distance, and activating or deactivating of a ventilation system within the predefined threshold distance.

At step 808, the method 800 comprises analyzing, by the at least one processor, the variation pattern of the airborne particulate matter over the predefined time period with respect to another variation pattern during the predefined time duration. In one embodiment, the another variation pattern is associated with another life safety detection device within a predefined threshold distance from the life safety detection device. In another embodiment, the another variation pattern is a predefined pattern associated with a ground truth airborne particulate matter detection device.

Further, the analyzing may include determining whether a deviation between the variation pattern of the airborne particulate matter and the another variation pattern is within a predefined threshold. Furthermore, the analyzing may include a passive trend analysis which can be achieved by monitoring via life safety detection devices in geometric proximity to each other and performing a statistical analysis, to verify whether a systemic change in correlation has not occurred over time. For instance, 7-day or 30-day average of a correlation coefficient may remain within a historically-observed range. Such metrics would be unique to a given deployment but would remain relatively constant over time unless an anomaly has occurred to an individual detector.

At step 810, the method 800 comprises evaluating, by the at least one processor, the operational aspect associated with the life safety detection device based on the analyzing step. In an embodiment, the evaluating may include evaluating that the life safety detection device is malfunctioning in response to a determining that the deviation is above a predefined threshold.

At step 812, the method 800 comprises transmitting, by the at least one processor, an alert indicating malfunctioning of the life safety detection device based on the evaluating step.

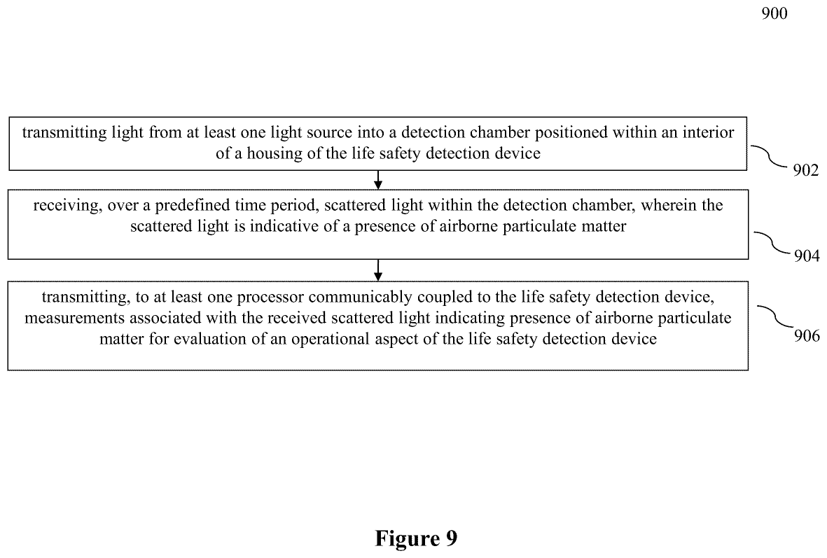

FIG. 9 illustrates a flow diagram depicting an exemplary method at the life safety detection device (e.g., 104) for evaluating the operational aspects of the life safety detection device.

At step 902, the method 900 comprises transmitting light from at least one light source into a detection chamber positioned within an interior of a housing of the life safety detection device.

At step 902, the method 900 comprises receiving, over a predefined time period, scattered light within the detection chamber, wherein the scattered light is indicative of a presence of airborne particulate matter.

At step 902, the method 900 comprises transmitting, to at least one processor communicably coupled to the life safety detection device, measurements associated with the received scattered light indicating presence of airborne particulate matter for evaluation of an operational aspect of the life safety detection device.

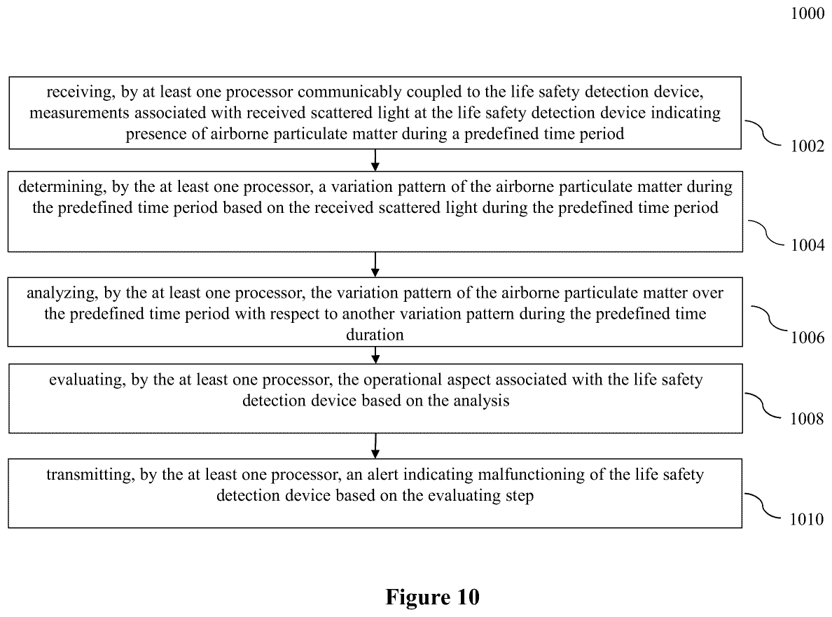

FIG. 10 illustrates a flow diagram depicting an exemplary method at the server (e.g., 110) for evaluating an operational aspect of the life safety detection device (e.g., 104).

At step 1002, the method 1000 comprises receiving, by at least one processor communicably coupled to the life safety detection device, measurements associated with received scattered light at the life safety detection device indicating presence of airborne particulate matter during a predefined time period.

At step 1004, the method 1000 comprises determining, by the at least one processor, a variation pattern of the airborne particulate matter during the predefined time period based on the received scattered light during the predefined time period. In an embodiment, the determining may include determining a variation pattern of the airborne particulate matter indicative of perturbation in the airborne particulate matter during an active stimulus associated with an event within a predefined threshold distance from the life safety detection device, and wherein the event perturbs air quality within the predefined threshold distance.

At step 1006, the method 1000 comprises analyzing, by the at least one processor, the variation pattern of the airborne particulate matter over the predefined time period with respect to another variation pattern during the predefined time duration. In an embodiment, the analyzing comprises determining whether a deviation between the variation pattern of the airborne particulate matter and the another variation pattern is within a predefined threshold.

At step 1008, the method 1000 comprises evaluating, by the at least one processor, the operational aspect associated with the life safety detection device based on the analysis. In an embodiment, the evaluating comprises evaluating that the life safety detection device is malfunctioning in response to a determining that the deviation is above a predefined threshold.

At step 1010, the method 1000 comprises transmitting, by the at least one processor, an alert indicating malfunctioning of the life safety detection device based on the evaluating step.

While the above steps of FIGS. 8-10 are shown and described in a particular sequence, the steps may occur in variations to the sequence in accordance with various embodiments of the disclosure. Further, the details related to various steps of FIGS. 8-10, which are already covered in the description related to FIGS. 1-7 are not discussed again in detail here for the sake of brevity.

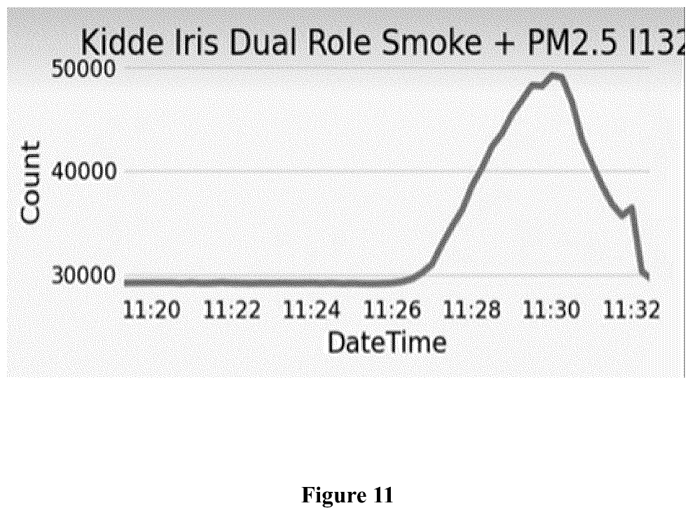

FIG. 11 illustrates a graphical representation of measurements associated with the particulate matter sensing functionality of the life safety detection device. As depicted, even small changes in background particulate matter trends, such as the increase at time index 11:26, are detectable through this enhanced sensing functionality, which is not present in typical life safety devices. Further, the particulate matter trends detected via life safety detection device may be used to verify unimpeded air flow being present around the life safety device.

The disclosure utilizes pre-existing air-quality trend data or data from ground truth particulate matter sensors to infer that the optical chamber is functioning properly. As discussed above, such inferences can be made by, for example, monitoring the magnitude of correlation coefficient between ground truth sensors and life safety detection devices that are in suitable geometric proximity, and maintain a correlation during normal operation. A reduction in magnitude of correlation from the normal condition may indicate a potential obstruction of airflow or smoke entry to the life safety device. This obviates any need for manual tests of airflow or smoke entry to be conducted for the life safety detection devices.

Without excluding further possible embodiments, certain example embodiments are summarized in the following clauses:

Clause 1: A method of evaluating an operational aspect of a life safety detection device, the method comprising: transmitting light from at least one light source into a detection chamber positioned within an interior of a housing of the life safety detection device; receiving, over a predefined time period, scattered light within the detection chamber, wherein the scattered light is indicative of a presence of airborne particulate matter; determining, by at least one processor communicably coupled to the life safety detection device, a variation pattern of the airborne particulate matter during the predefined time period based on the received scattered light during the predefined time period; analyzing, by the at least one processor, the variation pattern of the airborne particulate matter over the predefined time period with respect to another variation pattern during the predefined time duration; and evaluating, by the at least one processor, the operational aspect associated with the life safety detection device based on the analyzing step.

Clause 2: The method of clause 1, wherein the determining comprises determining a variation pattern of the airborne particulate matter indicative of perturbation in the airborne particulate matter during an active stimulus associated with an event within a predefined threshold distance from the life safety detection device, and wherein the event perturbs air quality within the predefined threshold distance.

Clause 3: The method of any of the preceding clauses, wherein the event comprises one of: activating or deactivating of a device within the predefined threshold distance, activating or deactivating of a sub-alarm threshold aerosol within the predefined threshold distance, change in state of one of a door, a window, or an object within the predefined threshold distance, and activating or deactivating of a ventilation system within the predefined threshold distance.

Clause 4: The method of any one of the preceding clauses, wherein the another variation pattern is associated with another life safety detection device within a predefined threshold distance from the life safety detection device.

Clause 5: The method of any one of the preceding clauses, wherein the another variation pattern is a predefined pattern associated with a ground truth airborne particulate matter detection device.

Clause 6: The method of any one of the preceding clauses, wherein: the analyzing comprises determining whether a deviation between the variation pattern of the airborne particulate matter and the another variation pattern is within a predefined threshold, and the evaluating comprises evaluating that the life safety detection device is malfunctioning in response to a determining that the deviation is above a predefined threshold.

Clause 7: The method of any of the preceding clauses further comprising: transmitting, by the at least one processor, an alert indicating malfunctioning of the life safety detection device based on the evaluating step.

Clause 8. A system of evaluating an operational aspect of a life safety detection device, the system comprising: a life safety detection device comprising: a housing defining a detection chamber for receiving ambient materials; at least one light source configured to emit light into the detection chamber; and at least one light sensing device configured to receive, over a predefined time period, scattered light reflected from the ambient materials in the detection chamber, wherein the scattered light is indicative of a presence of airborne particulate matter; and a processor communicably coupled to the life safety detection device, wherein the processor is configured to: determine a variation pattern of the airborne particulate matter during the predefined time period based on the received scattered light at the life safety detection device during the predefined time period; analyze the variation pattern of the airborne particulate matter over the predefined time period with respect to another variation pattern during the predefined time duration; and evaluate the operational aspect associated with the life safety detection device based on the analysis.

Clause 9. The system of any of the preceding clauses, wherein to determine the variation pattern, the processor is configured to determine a variation pattern of the airborne particulate matter indicative of perturbation in the airborne particulate matter during an active stimulus associated with an event within a predefined threshold distance from the life safety detection device, and wherein the event perturbs air quality within the predefined threshold distance.

Clause 10. The system of any of the preceding clauses, wherein the event comprises one of: activating or deactivating of a device within the predefined threshold distance, activating or deactivating of a sub-alarm threshold aerosol within the predefined threshold distance, change in state of one of a door, a window, or an object within the predefined threshold distance, and activating or deactivating of a ventilation system within the predefined threshold distance.

Clause 11. The system of any of the preceding clauses, wherein the another variation pattern is associated with another life safety detection device within a predefined threshold distance from the life safety detection device.

Clause 12. The system of any of the preceding clauses, wherein the another variation pattern is a predefined pattern associated with a ground truth airborne particulate matter detection device.

Clause 13. The system of any of the preceding clauses, wherein: to analyze the variation pattern, the processor is configured to determine whether a deviation between the variation pattern of the airborne particulate matter and the another variation pattern is within a predefined threshold, and to evaluate the operational aspect, the processor is configured to evaluate that the life safety detection device is malfunctioning in response to a determining that the deviation is above a predefined threshold.

Clause 14. The system of any of the preceding clauses, wherein the processor is further configured to: transmit an alert indicating malfunctioning of the life safety detection device based on the evaluating step.

Clause 15. A life safety detection device, comprising: a housing defining a detection chamber for receiving ambient materials; at least one light source configured to emit light into the detection chamber; at least one light sensing device configured to receive, over a predefined time period, scattered light reflected from the ambient materials in the detection chamber, wherein the scattered light is indicative of a presence of airborne particulate matter; and a communication interface configured to transmit to a processor, communicably coupled to the life safety detection device, measurements associated with the received scattered light indicating presence of airborne particulate matter for evaluation of an operational aspect of the life safety detection device.

Clause 16. A method of evaluating an operational aspect of a life safety detection device, the method comprising: transmitting light from at least one light source into a detection chamber positioned within an interior of a housing of the life safety detection device; receiving, over a predefined time period, scattered light within the detection chamber, wherein the scattered light is indicative of a presence of airborne particulate matter; and transmitting, to at least one processor communicably coupled to the life safety detection device, measurements associated with the received scattered light indicating presence of airborne particulate matter for evaluation of an operational aspect of the life safety detection device.

Clause 17. A system of evaluating an operational aspect of a life safety detection device, the system comprising: at least one processor communicably coupled to the life safety detection device, wherein the at least one processor is configured to: receive, from the life safety detection device, measurements associated with received scattered light indicating presence of airborne particulate matter during a predefined time period; determine a variation pattern of the airborne particulate matter during the predefined time period based on the received scattered light during the predefined time period; analyze the variation pattern of the airborne particulate matter over the predefined time period with respect to another variation pattern during the predefined time duration; and evaluate the operational aspect associated with the life safety detection device based on the analysis.

Clause 18. The system of any of the preceding clauses, wherein to determine the variation pattern, the at least one processor is configured to determine a variation pattern of the airborne particulate matter indicative of perturbation in the airborne particulate matter during an active stimulus associated with an event within a predefined threshold distance from the life safety detection device, and wherein the event perturbs air quality within the predefined threshold distance.

Clause 19. The system of any of the preceding clauses, wherein the event comprises one of: activating or deactivating of a device within the predefined threshold distance, activating or deactivating of a sub-alarm threshold aerosol within the predefined threshold distance, change in state of one of a door, a window, or an object within the predefined threshold distance, and activating or deactivating of a ventilation system within the predefined threshold distance.

Clause 20. The system of any of the preceding clauses, wherein the another variation pattern is associated with another life safety detection device within a predefined threshold distance from the life safety detection device.

Clause 21. The system of any of the preceding clauses, wherein the another variation pattern is a predefined pattern associated with a ground truth airborne particulate matter detection device.

Clause 22. The system of any of the preceding clauses, wherein: to analyze the variation pattern, the at least one processor is configured to determine whether a deviation between the variation pattern of the airborne particulate matter and the another variation pattern is within a predefined threshold, and to evaluate the operational aspect, the at least one processor is configured to evaluate that the life safety detection device is malfunctioning in response to a determining that the deviation is above a predefined threshold.

Clause 23. The system of any of the preceding clauses, wherein the at least one processor is further configured to: transmit an alert indicating malfunctioning of the life safety detection device based on the evaluating step.

Clause 24. A method of evaluating an operational aspect of a life safety detection device, the method comprising: receiving, by at least one processor communicably coupled to the life safety detection device, measurements associated with received scattered light at the life safety detection device indicating presence of airborne particulate matter during a predefined time period; determining, by the at least one processor, a variation pattern of the airborne particulate matter during the predefined time period based on the received scattered light during the predefined time period; analyzing, by the at least one processor, the variation pattern of the airborne particulate matter over the predefined time period with respect to another variation pattern during the predefined time duration; and evaluating, by the at least one processor, the operational aspect associated with the life safety detection device based on the analysis.

Clause 25. The method of any of the preceding clauses, wherein the determining comprises determining a variation pattern of the airborne particulate matter indicative of perturbation in the airborne particulate matter during an active stimulus associated with an event within a predefined threshold distance from the life safety detection device, and wherein the event perturbs air quality within the predefined threshold distance.

Clause 26. The method of any of the preceding clauses, wherein the event comprises one of: activating or deactivating of a device within the predefined threshold distance, activating or deactivating of a sub-alarm threshold aerosol within the predefined threshold distance, change in state of one of a door, a window, or an object within the predefined threshold distance, and activating or deactivating of a ventilation system within the predefined threshold distance.

Clause 27. The method of any of the preceding clauses, wherein the another variation pattern is associated with another life safety detection device within a predefined threshold distance from the life safety detection device.

Clause 28. The method of any of the preceding clauses, wherein the another variation pattern is a predefined pattern associated with a ground truth airborne particulate matter detection device.

Clause 29. The method of any of the preceding clauses, wherein: the analyzing comprises determining whether a deviation between the variation pattern of the airborne particulate matter and the another variation pattern is within a predefined threshold, and the evaluating comprises evaluating that the life safety detection device is malfunctioning in response to a determining that the deviation is above a predefined threshold.

Clause 30. The method of any of the preceding clauses further comprising: transmitting, by the at least one processor, an alert indicating malfunctioning of the life safety detection device based on the evaluating step. While specific language has been used to describe the subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. All such modifications and variations are intended to be included herein within the scope of this disclosure and protected by the following claims and their equivalents.

We claim:

1. A method of evaluating an operational aspect of a life safety detection device, the method comprising:
transmitting light from at least one light source into a detection chamber positioned within an interior of a housing of the life safety detection device;
receiving, over a predefined time period, scattered light within the detection chamber, wherein the scattered light is indicative of a presence of airborne particulate matter;
determining, by at least one processor communicably coupled to the life safety detection device, a variation pattern of the airborne particulate matter during the predefined time period based on the received scattered light during the predefined time period;
analyzing, by the at least one processor, the variation pattern of the airborne particulate matter over the predefined time period with respect to another variation pattern during the predefined time duration; and
evaluating, by the at least one processor, the operational aspect associated with the life safety detection device based on the analyzing step.

2. The method of claim 1, wherein the determining comprises determining a variation pattern of the airborne particulate matter indicative of perturbation in the airborne particulate matter during an active stimulus associated with an event within a predefined threshold distance from the life safety detection device, and wherein the event perturbs air quality within the predefined threshold distance.

3. The method of claim 2, wherein the event comprises one of:
activating or deactivating of a device within the predefined threshold distance,
activating or deactivating of a sub-alarm threshold aerosol within the predefined threshold distance,
change in state of one of a door, a window, or an object within the predefined threshold distance, and
activating or deactivating of a ventilation system within the predefined threshold distance.

4. The method of claim 1, wherein the another variation pattern is associated with another life safety detection device within a predefined threshold distance from the life safety detection device.

5. The method of claim 1, wherein the another variation pattern is a predefined pattern associated with a ground truth airborne particulate matter detection device.

6. The method of claim 1, wherein:
the analyzing comprises determining whether a deviation between the variation pattern of the airborne particulate matter and the another variation pattern is within a predefined threshold, and
the evaluating comprises evaluating that the life safety detection device is malfunctioning in response to a determining that the deviation is above a predefined threshold.

7. The method of claim 6 further comprising:
transmitting, by the at least one processor, an alert indicating malfunctioning of the life safety detection device based on the evaluating step.

8. A system of evaluating an operational aspect of a life safety detection device, the system comprising:
a life safety detection device comprising:
a housing defining a detection chamber for receiving ambient materials;
at least one light source configured to emit light into the detection chamber; and
at least one light sensing device configured to receive, over a predefined time period, scattered light reflected from the ambient materials in the detection chamber, wherein the scattered light is indicative of a presence of airborne particulate matter; and
a processor communicably coupled to the life safety detection device, wherein the processor is configured to:
determine a variation pattern of the airborne particulate matter during the predefined time period based on the received scattered light at the life safety detection device during the predefined time period;
analyze the variation pattern of the airborne particulate matter over the predefined time period with respect to another variation pattern during the predefined time duration; and
evaluate the operational aspect associated with the life safety detection device based on the analysis.

9. The system of claim 8, wherein to determine the variation pattern, the processor is configured to determine a variation pattern of the airborne particulate matter indicative of perturbation in the airborne particulate matter during an active stimulus associated with an event within a predefined threshold distance from the life safety detection device, and wherein the event perturbs air quality within the predefined threshold distance.

10. The system of claim 9, wherein the event comprises one of:
activating or deactivating of a device within the predefined threshold distance,
activating or deactivating of a sub-alarm threshold aerosol within the predefined threshold distance,
change in state of one of a door, a window, or an object within the predefined threshold distance, and
activating or deactivating of a ventilation system within the predefined threshold distance.

11. The system of claim 8, wherein the another variation pattern is associated with another life safety detection device within a predefined threshold distance from the life safety detection device.

12. The system of claim 8, wherein the another variation pattern is a predefined pattern associated with a ground truth airborne particulate matter detection device.

13. The system of claim 8, wherein:
to analyze the variation pattern, the processor is configured to determine whether a deviation between the variation pattern of the airborne particulate matter and the another variation pattern is within a predefined threshold, and
to evaluate the operational aspect, the processor is configured to evaluate that the life safety detection device is malfunctioning in response to a determining that the deviation is above a predefined threshold.

14. The system of claim 13, wherein the processor is further configured to:
transmit an alert indicating malfunctioning of the life safety detection device based on the evaluating step.

15. A life safety detection device, comprising:
a housing defining a detection chamber for receiving ambient materials;
at least one light source configured to emit light into the detection chamber;
at least one light sensing device configured to receive, over a predefined time period, scattered light reflected from the ambient materials in the detection chamber, wherein the scattered light is indicative of a presence of airborne particulate matter; and
a communication interface configured to transmit to a processor, communicably coupled to the life safety detection device, measurements associated with the received scattered light indicating presence of airborne particulate matter for evaluation of an operational aspect of the life safety detection device.
